(19) United States
(12) Patent Application Publication
(10) Pub. No.: US 2010/0316141 A1
(43) Pub. Date: Dec. 16, 2010

(54) Method and Apparatus for Extending Receiver-Biased Digital Links

(76) Inventor: Howard Vincent Derby, Boulder, CO (US)

Correspondence Address: Howard Vincent Derby, 602 Clover Lane, Boulder, CO, 80303, US

(21) Appl. No.: 12/814,479

(22) Filed: Jun. 13, 2010

Related U.S. Application Data
(60) Provisional application No. 61/186,961, filed on Jun. 15, 2009.

(51) Int. Cl. H04B 3/00

(52) U.S. Cl. 375/257

(57) ABSTRACT

A new design is shown for a digital link that does not require additional power for transmitter biasing when copper media a in receiver-biased digital link is replaced with an alternative link medium. This power savings can be crucial is certain applications, such as HDMI or DVI bus extension where the available power resources are highly constrained.

### CROSS-REFERENCE TO RELATED APPLICATIONS

This application claims the benefit of U.S. Provisional application No. 61/186,961, entitled “Extended Receiver-Biased Digital Links”, filed on Jun. 15, 2009.

### STATEMENT REGARDING FEDERALLY SPONSORED RESEARCH OR DEVELOPMENT

Not Applicable

### BACKGROUND OF THE INVENTION

1. Field of the Invention

This invention relates to high-speed digital communications links. More specifically, it relates to differential signaling systems in which bias for the output stage of the transmit end of the link is provided by the receive end of the link, and the replacement of copper media therein.

Many electronic systems use terminated differential interconnections to form high-speed digital data links from one location to another. In many cases, bias to the transmit output stage is provided by the receiver termination resistors; HDMI and DVI digital video are common examples that use this structure. Interconnect with simple copper cables can become impractical or expensive as distance or bandwidth increase. In such cases, it may be desirable to replace a simple copper interconnect with a higher performance link medium, such as optical fiber or an equalized copper interconnect, thereby enhancing link performance.

When such techniques are applied to receiver termination powered links, there is an additional power penalty beyond that required for the alternative link—power must be supplied for biasing the transmitter output stage. The present invention provides a method for biasing the transmit stage from the receiver termination without a galvanic connection in the high-speed signal path. This allows higher-performance link technologies to replace simple transmission lines without requiring additional power to bias the transmitter output stage.

2. Description of the Prior Art

A typical receiver-biased differential link is shown in FIG. 1. The output stage of transmitting unit (1) consists of a differential pair (2) driven by a pre-driver at points (3). The transmitter output stage shown in FIG. 1 uses NPN bipolar transistors; those skilled in the art will recognize the applicability of other devices to the same basic design.

The differential pair is operated at a nearly constant-current I_{bias} by current source (4). Bias current for output stage (2) is provided by power supply (5), which is part of receiving unit (6). The bias current flows through terminating resistors (7) and differential signal interconnect (8). The DC return path for the bias current is provided by the ground interconnect (9), which establishes a common DC ground between the transmitting unit (1) and the receiving unit (6). Output stage (2) derives the electrical power needed for biasing from the bias current, thus the bias power for output stage (2) is provided by power supply (5) in receiving unit (6).

Data is signaled by the switching action of differential pair (2), causing the current in current source (4) to be sunk on one or the other of the differential signal interconnect lines (8). This current switching results in different voltage drops across the two terminating resistors (7); the resulting differential voltage is conditioned by differential receiver amplifier (10) for use by receiving unit (6). By this means, digital data is communicated from transmitting unit (1) to receiving unit (6).

The signal interconnect (8) and ground interconnect (9) are shown as dotted lines, indicating that this part of the circuit may be formed by a cable of substantial length, allowing the transmitter and receiver to be located a substantial distance apart.

In some cases, it may be desirable to replace the simple galvanic signal interconnect shown in FIG. 1 with an enhanced link structure that offers higher performance. Such an application is illustrated in FIG. 2. In this example, high-performance link (21) replaces differential transmission line (8) shown in FIG. 1. High-performance link (21) is shown as an abstract arrow; the details of link implementation are not significant to the present disclosure. Bias for output driver (22) is provided through termination resistors (23) and is sourced from power supply connection (24). In addition to the power needed by high-performance link (21), power is also drawn from power supply (24) to bias output stage (22); this often makes the prior art impractical.

BRIEF SUMMARY OF THE INVENTION

The present invention eliminates the problem of transmitter biasing with an enhanced link by providing a alternative path for bias power that is not used for data transmission, as illustrated in FIG. 3.

As in FIG. 1 and FIG. 2, transmitting unit (31) sends data to receiving unit (32) via a digital link.

The differential output from transmitter output stage (33) is conveyed by high-performance link (34) to the differential inputs of receiver amplifier (35), which conditions the signal for use by receiving unit (32).

Instead of providing separate biased termination for output stage (33), the present invention uses alternative path (36) to carry bias power from receiving unit (32) to transmitting unit (31); said power is obtained from receiving unit (32) and is used to provide bias current for output stage (33). To prevent this path from interfering with high-frequency data transmission, isolation means (37) are used to isolate high-frequency signal nodes (38) and (39) from alternative path (36). This isolation ensures that signal integrity is preserved regardless of the high-frequency characteristics of alternative path (36).

In one embodiment of the present invention, isolation means (37) consists of ferrite beads, chokes, or inductors, and alternative path (36) is a galvanic connection. The bias current necessary for output stage (33) is routed directly through alternative path (36), which conveys bias power from receiving unit (32) to output stage (33).

Where isolation means (37) is implemented using ferrite beads, chokes, or inductors, the separation of signal and bias is based on frequency, with bias current being at DC and the signal currents being at high frequency. Separation of bias and signal currents based on frequency requires that the digital data be modulated in an approximately DC-balanced manner; the use of DC-balanced codes is typical of the modulation schemes used in high-speed digital communications and thus the DC-balance requirement does not pose a significant obstacle to utilization of the present invention with said means.

Other isolation means may impose different requirements on the signaling regime, as will be apparent to those skilled in the art. Some isolation means may lose substantial energy and require an alternative path (36) capable of supplementing the bias power obtained from the receiver.

### BRIEF DESCRIPTION OF THE DRAWINGS

FIG. 1 shows a receiver-biased digital link typical of the prior art.

FIG. 2 shows the prior art for including a high-performance link in a receiver-biased transmitter system.

FIG. 3 shows an alternative structure for a receiver-biased digital link that illustrates the principles behind the present invention.

FIG. 4 and FIG. 5 show preferred embodiments of the present invention.

FIG. 6 shows a further application of the present invention to bi-directional links.

### DETAILED DESCRIPTION OF THE INVENTION

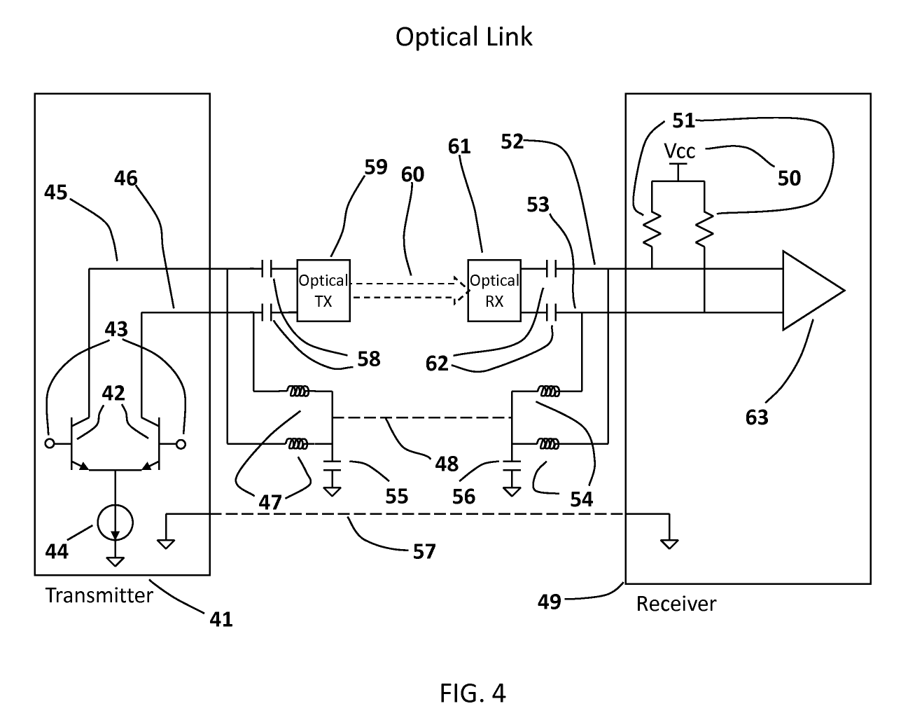

FIG. 4 shows one preferred embodiment of the present invention.

Transmitting unit (41) consists of a differential pair output driver (42) driven by a pre-driver stage at points (43), biased to an approximately constant current I_{bias} by current source (44). The input drive applied at points (43) causes the differential output stage (42) to sink current from either collector output (45) or collector output (46), depending upon the differential voltage applied at point (43).

Because the data being applied at points (43) is approximately DC-free, the average current sunk from both (45) and (46) is I_{bias}/2. The average current will flow through the AC-blocking ferrite beads (47) into galvanic connection (48), which carries the combined current from both ferrite beads (47).

Within the receiving unit (49), power supply (50) sources the current flowing through galvanic connection (48). Receiver termination resistors (51) each source an average current of I_{bias}/2 into nodes (52) and (53). This current is carried to galvanic connection (48) by ferrite beads (54).

The total average current sourced by the receiver termination (51) is set by transmitter current source (44), as it is the only DC current sink path provided in the circuit. The average source current is divided equally between the termination resistors (51), as ferrite beads (54) provide a low resistance path at DC between nodes (52) and (53), thus forcing the average voltage across each termination resistor (51) to be equal.

In the present embodiment, bias for transmitter output driver (42) is provided from receiver input termination (51) via galvanic connection (48). Since the bias current is provided by the receiver just as with a direct galvanic connection between transmitter and receiver, no additional power is required to bias the transmitter output stage. The only additional power necessary is that required to power the high-performance link, namely that for optical transmitter (59) and optical receiver (61). Galvanic connection (48) is for biasing only, and has no high-frequency electrical requirements. Inexpensive wiring can be used, without concerns for EMI radiation or excessive signal losses at high frequencies. This allows the interconnection length to be much greater than could be achieved using a direct galvanic connection between transmitter and receiver.

To further ensure against RF energy reaching galvanic connection (48), bypass capacitors (55) and (56) are used to shunt any high-frequency leakage through ferrite beads (47) and (54) to local electrical ground. Galvanic connection (57) creates a common low-frequency ground between the transmitter (41) and receiver (49), completing the circuit for I_{bias}.

The high-frequency signal created by the switching of transmitter output stage (42) passes through AC-coupling capacitors (58) into the optical transmitter (59). The electrical inputs to optical transmitter (59) are terminated with the same differential impedance provided by receiver termination resistors (51). This ensures that transmitting unit (41) sees the same load impedance that it would were it directly connected to receiving unit (49).

Transmitter (59) converts the electrical signals at its inputs to an optical signal, which is carried by optical fiber (60) to optical receiver (61). Optical receiver (61) converts the optical signal to a differential electrical signal, which is coupled via AC-coupling capacitors (62) to the input of receiving unit (49). The output of optical RX (61) may be terminated or not, and must have signal levels that are compatible with receiving unit (49). Differential amplifier (63) conditions the differential signal between nodes (52) and (53) for use by receiving unit (49). Thus, the digital data provided by transmitting unit (41) at nodes (43) is conveyed to receiving unit (49) via the optical fiber (60).

AC-coupling capacitors (58) are not strictly required in this preferred embodiment, but are necessary when the input voltage characteristics of optical transmitter (59) are not compatible with the DC operating point established by transmitting unit (41) and receiving unit (49). Similarly, AC-coupling capacitors (62) may be omitted if optical receiver (61) is compatible with said DC operating point.

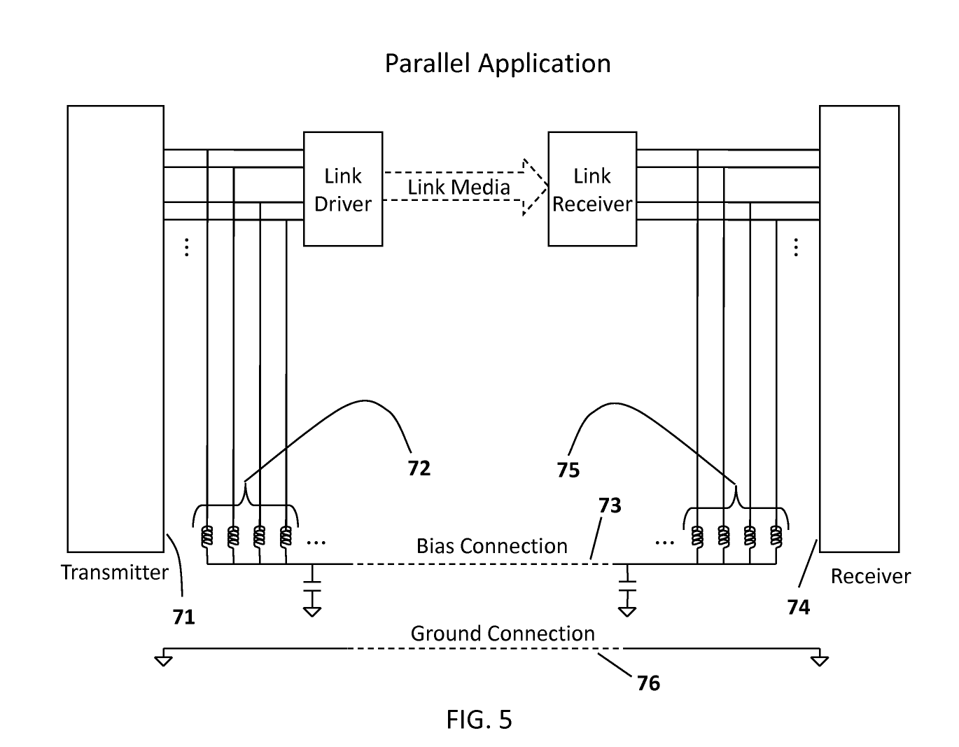

FIG. 5 shows a preferred embodiment for a parallel link in which the transmitter and receiver have multiple channels. The output bias current for parallel transmitting unit (71) is provided via the AC-blocking ferrite beads (72), which couple all of the bias current into a single shared galvanic connection (73). The bias current is collected from the inputs of receiving unit (74) using AC-blocking ferrite beads (75). In this way, only a single galvanic bias connection (73) is required for all channels. Where constrained by wire resistance, multiple parallel connections may be used to convey bias current from receiving unit (74) to transmitting unit (71).

Multiple conductors may be utilized in several other ways. The receive channels may be treated as a separate nodes, with their own separate bias current routing, each route being comprised of one or several conductors. Alternatively, the multiple receive channels may be arranged into groups, each group having its own bias current route, which is again comprised of one or several conductors.

It is not necessary for a transmitting unit's bias current to originate from the corresponding receiving unit, so long as the bias current levels are compatible. In a system with multiple channels, there are many different bias current interconnect possibilities that all utilize the principles of the present invention.

The use of multiple conductors to mitigate resistance applies equally to bias connection (73) and ground connection (76).

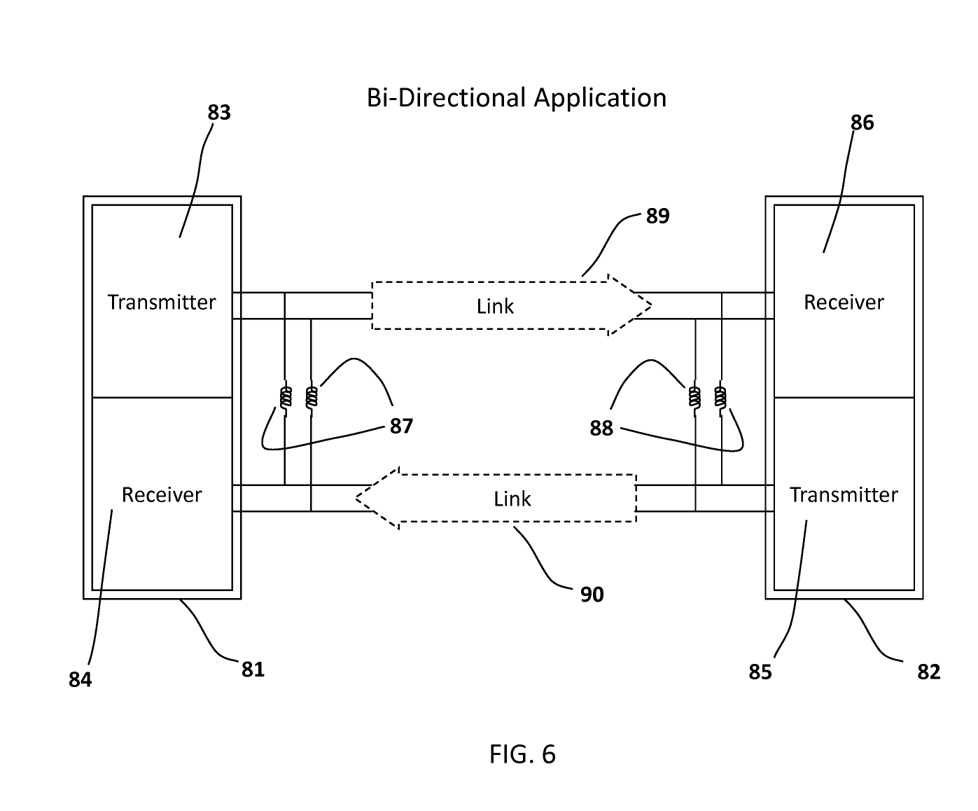

FIG. 6 shows an alternative interconnection structure for bi-directional applications. Units (81) and (82) are connected by bi-directional communications paths. Unit (81) contains a transmitter (83) and a receiver (84). Similarly, unit (82) contains a transmitter (85) and a receiver (86). This allows unit (81) to transfer digital data to unit (82), and vice versa.

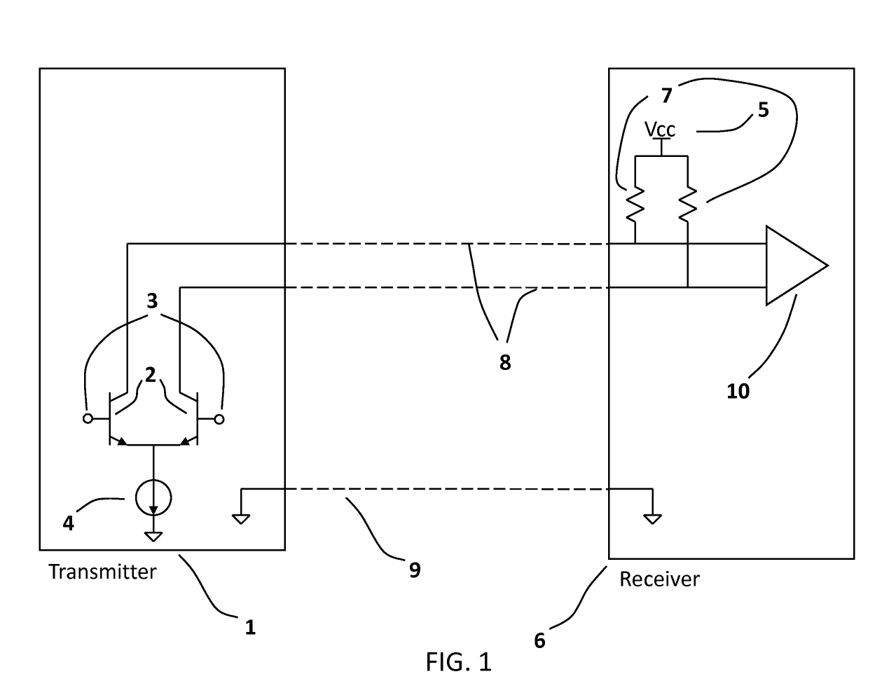

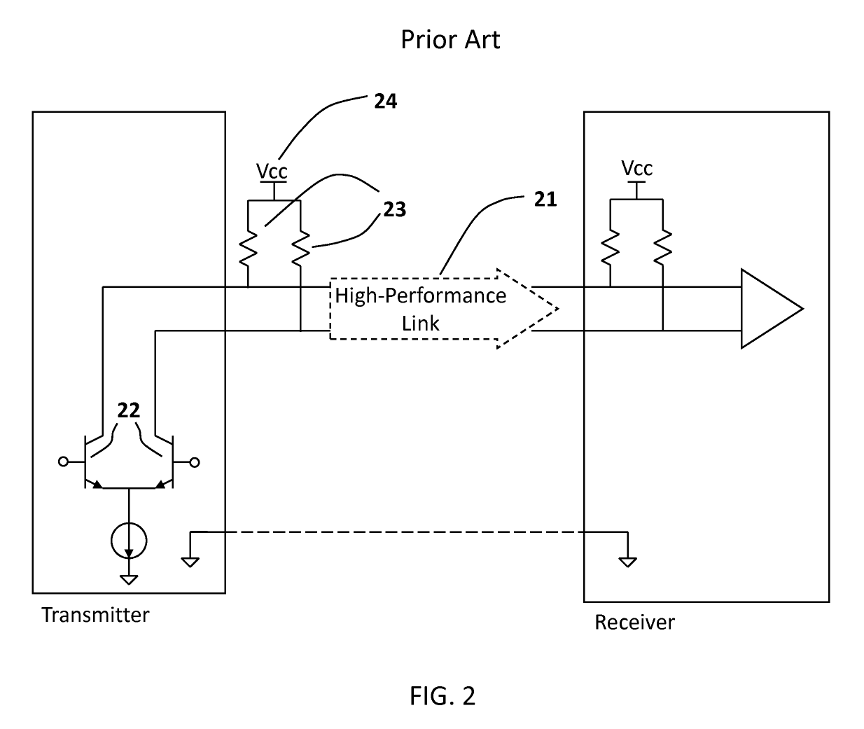

The transmitters (83) and (85) are of similar design to transmitter (1) in FIG. 1. The receivers (84) and (86) are of similar design to receiver (6) in FIG. 1.

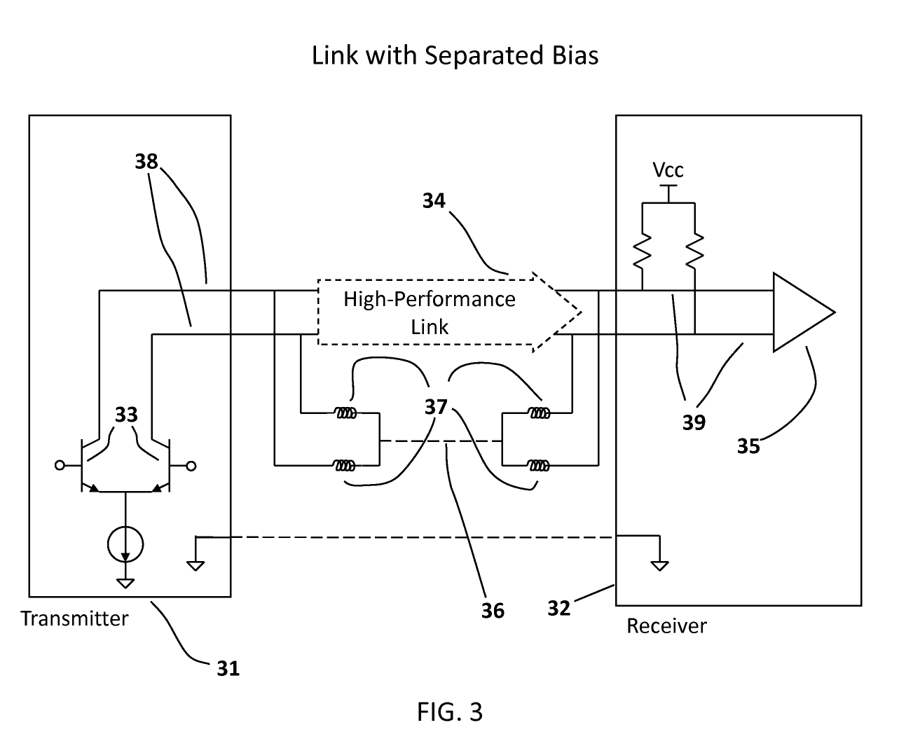

Transmitters (83) and (85) both require biasing from receiver termination. In the prior art, bias for transmitter (83) in unit (81) would be provided by receiver (86) in unit (82) via a direct galvanic connection in the form of a differential transmission line. A direct application of the present invention as shown in FIG. 3 could be made in this case, with two galvanic bias connections, one in each direction. However, bi-directional applications admit a further simplification in which receiver (84) provides the bias for transmitter (83), and receiver (86) provides the bias for transmitter (85). This is achieved using AC-blocking ferrite beads (87) and (88). Data is carried from unit (81) to unit (82) via link (89), and data is carried from unit (82) to unit (81) via link (90). The two units are now self-biasing. If links (89) and (90) are optical, this invention has the further advantage of not requiring any galvanic connection between units (81) and (82).

What is claimed is:

1. A digital link of one or more channels in which bias power is coupled in whole or in part from receiver to transmitter using one or more bias coupling paths other than those paths used for signaling data.

2. The link of claim 1, where the bias coupling path or paths are implemented using a galvanic connection.

3. The link of claim 1, where the bias coupling path or paths are isolated using inductors, chokes, or ferrite beads.

4. The link of claim 1, where the information being conveyed is TMDS encoded data or a TMDS clock.

5. The link of claim 2, where the information being conveyed is TMDS encoded data or a TMDS clock.

6. The link of claim 3, where the information being conveyed is TMDS encoded data or a TMDS clock.

7. A bi-directional digital link in which the transmitter bias at either end is provided in whole or in part from receivers at the same end.

8. A bi-directional digital link in which the methods of claim 7 are applied at both ends.
